(19) United States
(12) Patent Application Publication
(10) Pub. No.: US 2013/0139507 A1
(43) Pub. Date: Jun. 6, 2013

(54) Thermal Compression and Waste Heat Recovery Heat Engine and Methods

(71) Applicant: Arthur P. Morse, Lansdale, PA (US)

(72) Inventor: Arthur P. Morse, Lansdale, PA (US)

(21) Appl. No.: 13/490,445

(22) Filed: Jun. 6, 2012

Related U.S. Application Data
(60) Provisional application No. 61/493,622, filed on Jun. 6, 2011.

(51) Int. Cl. F02G 5/00

(52) U.S. Cl. CPC F02G 5/00
USPC 60/624

(57) ABSTRACT

A system for converting thermal energy from combusting fuel and air into work under an isochoric process. A reciprocating heat engine creates a cycle delay after combustion to enable sufficient time for thermal compression to occur within the working gas and within a constant volume to maximize thermal compression. A secondary engine also includes a cycle delay to maximize thermal compression of a working gas by recovering waste heat from the exhaust of the primary heat engine and converting a percentage of that heat energy into work. System cooling is accomplished under a thermodynamic cycle with heat from a liquid medium, such as water, passing through the internal combustion engine block or heat exchanger being conserved and applied to useful auxiliaries, such as residential hot water heating, baseboard heating, radiant floor heating.

### FIELD OF THE INVENTION

The present invention relates generally to systems and methods for energy conversion. More particularly, disclosed herein are high-efficiency systems and methods for converting potential energy in a fuel to kinetic energy through a heat engine and, in certain embodiments, for employing that energy to produce electricity and other applications.

### BACKGROUND OF THE INVENTION

Traditional heat engines convert potential energy to kinetic energy by a moderate pressure rise after combustion resulting from heat being transferred into a working fluid, typically compressed air. After air is compressed, heat is added to the compressed air from combustion resulting in a moderate pressure rise within a confined space as predicted by the Ideal Gas Law. Hot air and combustion gasses are then expanded, and work is applied to a crank shaft resulting in a power stroke. The absolute difference between the work-in from compression and the work-out from expansion is the net-work produced by the engine.

Pursuant to the first law of thermodynamics, only a percentage of the potential energy can be converted to net-work. The remaining energy is discharged as waste heat thus accounting for all available energy. Typically, the auto cycle, the diesel cycle, the gas turbine cycle, as well as the Rankin cycle convert less than 40% of the available potential energy in fuels to usable work. Under an engine load, some systems are well below 35% recovery.

A number of inventors have contributed usefully to the state of the art in seeking to accomplish varied objects, including increased efficiency, improved performance, and other important benefits. The following are some of the many disclosures with teachings in the field of the present invention: U.S. Pat. No. 7,134,285 to Primlani for Adiabatic Power Generating System, U.S. Pat. No. 6,955,052 to Primlani for a Thermal Gas Compression Engine, U.S. Pat. No. 4,911,110 to Isoda et al. for a Waste Heat Recovery System for Liquid-Cooled Internal Combustion Engine, U.S. Pat. No. 7,021,059 to Shinohara et al. for a Heat Exchange System, U.S. Pat. No. 7,669,560 to Elsbett for a Gas Exchange Control Mechanism for an Opposed-Piston Engine, U.S. Pat. No. 4,841,928 to Paul et al. for a Reciprocal Engine with Floating Liner, U.S. Pat. No. 7,389,755 to Noland for a Tandem-Piston Engine, U.S. Nos. 7,255,067 and 7,299,770 to Thorpe for Evaporative In-Cylinder Cooling, U.S. Pat. No. 4,838,213 to Gerace for a Thermal Ignition Method and Apparatus for Internal Combustion Engines, U.S. Pat. No. 5,562,079 to Gray et al. for a Low-Temperature, Near-Adiabatic Engine, U.S. Pat. No. 6,581,381 to Chang Sun Kim for an Engine having Adiabatic Members in its Combustion Chambers, Engine Capable of Reusing Exhausted Energy, and High Pressure Jet Assembly having the Engine, U.S. Pat. No. 4,781,157 to Wade et al. for a Multipart Ceramic Cylinder head, U.S. Pat. No. 4,796,572 to Heydrich for a Combustion Chamber Liner, U.S. Pat. No. 5,413,877 to Griffith for Combination Thermal Barrier and Wear Coating for Internal Combustion Engines, U.S. Pat. No. 5,139,876 to Graham et al. for a Ceramic Article Having Wear Resistant Coating, U.S. Pat. No. 4,872,432 to Rao et al. for an Oilless internal combustion engine having gas phase lubrication, U.S. Pat. No. 4,800,853 to Kraus et al. for an Adiabatic Internal Combustion Engine, U.S. Pat. No. 4,777,844 to DeBell et al. for Hybrid Ceramic/Metal Compression Sink for Use in Higher Temperature Application, U.S. Pat. No. 6,089,195 to Lowi et al. for an Adiabatic, Two-Stroke Cycle Engine Having External Piston Rod Alignment, U.S. Pat. No. 6,295,965 to Firey for an Engine Cylinder Stratifier, U.S. Pat. No. 5,799,629 to Lowi et al. For an Adiabatic, Two-Stroke Cycle Engine Having External Piston Rod Alignment, U.S. Pat. No. 6,279,520 to Lowi for an Adiabatic, Two-stroke Cycle Engine having Novel Scavenge Compression Arrangement, U.S. Pat. No. 5,375,567 to Lowi et al. for an Adiabatic, Two-Stroke Cycle Engine, and U.S. Pat. No. 5,507,253 to Lowi for an Adiabatic, Two-Stroke Cycle Engine Having Piston-Phasing and Compression. The entirety of each of these disclosures is expressly incorporated herein by reference.

Despite these and further contributions to the art, there remains a recognized and long-felt need in the art for high-efficiency systems and methods for converting potential energy in a fuel to kinetic energy through a heat engine and for employing that energy to produce electricity and other useful benefits.

### SUMMARY OF THE INVENTION

With an appreciation for the state of the art, the present inventor set forth with the basic object of providing a system and method for enabling a more efficient transfer of energy from potential to kinetic forms through a thermal compression internal combustion heat engine, a thermal compression waste heat recovery heat engine, a co-generation waste heat transfer system and point-of-use energy management approach to enable a more efficient use of energy as it is consumed from a fuel and converted to work and heat at a stationary facility. The invention can be configured in a hybrid arrangement where each system operates simultaneously and in cooperation or separately as independent units for different applications. Embodiments of the invention seek to provide a system and method for exploiting energy harvested from fuels or heat to generate electricity or provide work and to employ the same as a source of alternative energy for residential, commercial, and other uses.

Other applications of the invention include direct power for driving stationary systems, such as heat pumps, energy storage systems, or industrial equipment. Transportation applications can include an efficient method for charging batteries in hybrid heat engine/electric drive motor systems, such as in hybrid passenger vehicles, locomotives, and marine applications.

An underlying object of embodiments of the invention is to offer a green, alternative energy converter to satisfy current energy demand while providing energy conservation, reducing energy costs for users, reducing greenhouse gases per consumed Kwh, and contributing to energy independence from the power grid by offering to consumers a low cost per kilowatt-hour alternative to purchasing line current from local utilities through high-efficiency, point-of-use power generation combined with energy management and energy conservation as compared to prior art applications.

Another object of the embodiments of the invention is to offer a system and method for recovering waste heat from large heat sources and offering a self-sustaining and clean method, completely free of green house gas emissions, to convert a percentage of that available heat into work to generate electricity or to drive other applications.

A further object of embodiments of the invention is to minimize moving parts thereby to create a robust and durable system that is efficient in manufacture.

Still another object of embodiments of the invention is to minimize heat losses in relation to a thermal compression internal combustion heat engine and, additionally or alternatively, a thermal combustion waste heat recovery system through internal insulating liners and the utilization of liquid, such as water, injection in the combustion and thermal compression steps.

Still other objects of embodiments of the invention are to provide a hybrid system that combines a thermal compression internal combustion engine and thermal compression waste heat recovery system to convert potential energy in a fuel to kinetic energy efficiently thus maximizing overall system efficiency and further lowering fuel consumption, fuel costs, and greenhouse gas emissions.

These and in all likelihood further objects and advantages of the present invention will become obvious not only to one who reviews the present specification and drawings but also to those who have an opportunity to witness embodiments of the system and methods disclosed herein in operation. However, it will be appreciated that, although the accomplishment of each of the foregoing objects in a single embodiment of the invention may be possible and indeed preferred, not all embodiments will seek or need to accomplish each and every potential advantage and function. Nonetheless, all such embodiments should be considered within the scope of the present invention.

Heat addition to a compressed ideal gas held at a constant volume results in a rise in pressure of that same gas without introducing additional work to the system. This process is known as an isochoric process and will be referred to as thermal compression. Pursuant to the Ideal Gas Law, when air volume remains constant during heat addition, temperature rises and the corresponding gas pressure will also rise. The final pressure P₂ equals the initial pressure P₁ times the final temperature T₂ divided by the initial temperature T₁ where the initial volume V₁ equals the final volume V₂.

In view of the foregoing and in carrying forth the objects set forth above, the present invention contemplates thermal compression in multiple thermal air cycles. A basic embodiment of the invention provides efficient transfer of potential energy to kinetic energy thermal compression, a hybrid multi-cycle system, and energy conservation. The hybrid thermal compression heat engine can have at least two thermal air cycles with the primary or first cycle employing an air compressor with atmospheric air and fuel drawn into the system by a small vacuum at a constant mass flow rate. Fresh intake air and atomized fuel or gaseous fuel are compressed, which results in a higher temperature and pressure of the air and fuel mixture, in a combustion chamber. The compressor can be lined with insulation located behind bearing surfaces to reduce heat losses. Heat from compression and friction is transferred into the combustion chamber.

The combustion chamber contains sufficient mechanical integrity and materials to contain the internal pressures and temperatures typical of combustion. These supporting structures are preferably insulated from the heat of combustion by internal insulators. Ignition is initiated by a spark plug or by auto ignition with ignition timed to align with the operational timing of the cycle. Combustion occurs in the same confined space at a constant volume. According to the Ideal Gas Laws, internal pressure of the gas rises with a corresponding rise in internal air temperature.

Sufficient time must be allowed for the air to absorb the heat of combustion and compressed air. Where combustion and heat transfer requires more time to occur than a single compression step allows, multiple combustion and thermal compression chambers are allocated.

The number of compression and expansion cycles per combustion and thermal compression chamber is equivalent to the number of combustion and thermal compression chambers between the compressor and expander heads. The combustion and thermal compression chambers operate in series with overlapping cycles, enabling one chamber sufficient time to undergo combustion and thermal compression while another has completed that step and is feeding the expander and a third may be undergoing mechanical compression.

After combustion and thermal compression, hot air expands through a separate expander where the volume increases and work is applied to the expander and the temperature of the air reduces at constant entropy minus friction and thermal losses. Expansion occurs adiabatically as the expander walls are insulated to prevent thermal losses to the engine block and other mechanical structures. After full expansion, air containing residual heat and waste products from combustion is exhausted as waste, and the cycle is repeated.

Exhaust gases containing waste heat then interact in a second thermal heat cycle. There, ambient air is draw into a second compressor and is compressed adiabatically as described above. Warm, compressed air is fed into a heat exchanger where a fixed absolute quantity is supplied. After filling, the heat exchanger inlet is closed thereby preventing gas from escaping, and then a second heat exchanger is filled through the sequencing of inlet valves. Compressed air is maintained at a constant volume as exhaust gases from the first cycle pass through the “hot” side of the heat exchanger and heat within the exhaust gases is transferred to the compressed air being held at a constant volume. After a predetermined resident time, the compressed air undergoes thermal compression as heat is transferred into the compressed air from the hot exhaust gases. The compresses air temperature and the internal pressure rise while the temperature of the exhaust gasses lowers as heat is transferred from one gas to the other.

After thermal compression is complete, the intake valve opens again and the now hot thermally compressed air at the volume as before thermal compression occurred “pulses” into an expander by means of valve sequencing where it applies work to an expander. The expander operates continuously where a multiplicity of what can be referred to as pulse heat exchangers continuously cycle and are timed to operate in a continuous sequence in which one pulse heat exchange finishes a pulse into the expander while the next pulse heat exchanger begins the next pulse. A sufficient number of heat pulse heat exchangers are installed in the system to assure continuous operation of the compressor and expander at a desired rotational speed.

The difference between the input work required driving the compressor and the output work recovered from the expander is the net work of the second cycle, which provides supplemental work to that produced by the first cycle. This supplemental work is the waste heat recovery stage of the system and contributes to the overall system efficiency. Waste heat recovery is performed by transferring heat to compressed air held at a constant volume, which results in a pressure rise to make the conversion of waste heat into work a possibility.

Once exhaust gases for the first cycle exit the pulse heat exchangers, it is exhausted into atmospheric air. Likewise, when waste air from the second cycle exits the second expander, it is also discharged or returned to atmospheric air. In both cases, the exhaust temperatures are lower than conventional heat engines thereby resulting is less waste heat. Better potential energy to kinetic energy conversion yields improved thermal efficiency with less fuel consumption and lower greenhouse gas emissions than traditional heat engines.

It will thus be recognized that the present invention discloses systems and methodologies for, among other things, transferring heat into air in a piston engine, after compression, at a constant volume for a sufficient period to complete heat transfer and better maximize thermal compression and improve overall cycle efficiency. Although there are many reasons for low energy conversion rates under the prior art, embodiments of the invention focus on five key strategies for the efficient conversion of fuel to a useful application over existing Auto and Diesel engines and applications by proposing the following and other improvements:
1. Increasing the dwell time of compressed gasses to maximize thermal compression during combustion in an isochoric process;
2. Providing dedicated compression and expansion cylinders of different volumes with expansion cylinder being a larger volume to account for a larger air volume after combustion. In this regard, it will be noted that, pursuant to the ideal gas law, the same mass of air pursues an increased volume at higher temperatures, such as after the combustion phase;
3. Providing multiple work recovery steps during expansion to generate additional shaft work without consuming additional fuel. According to the third law of thermal dynamics, all available energy in a working fluid cannot be converted to work in one step. Therefore, multiple work recovery steps are proposed.
4. Proposing a co-generation step to recover waste heat to provide a heat source for hot water, building heating, and other auxiliary heating systems for residences and business applications without consuming additional fuel.
5. Proposing a continuous use and point-of-use stationary system dedicated to a facility, whether a home, business, apartment, or other location, to enable a practical co-generation of heat energy for secondary uses, such as room heating, hot water heating, pools, and other applications.

As described and shown herein, there are two compression steps: mechanical compression and thermal compression. Thermal compression occurs without any additional mechanical work added to the system and yields a much higher expansion pressure and, consequently, a much higher expansion range than traditional piston engines. This results in higher system efficiencies. Since more heat from combustion is converted to work from the same fuel combustion rate, the system and method are consistent with the first law of thermal dynamics.

It is also recognized that residual heat in exhaust air after expansion is typically wasted. This waste accounts for most of the energy losses in a typical heat engine or stack gas. The present invention seeks to recycle waste heat into work and to employ waste heat as a secondary energy source by transferring that heat into at least one additional compressed air cycle. The disclosed invention also transfers heat into mechanically compressed air at a constant volume resulting in a thermal compression heat transfer step.

It is known that heat engines are either liquid or air cooled to prevent thermal damage to the engine block. While this advantageously protects the engine internal bearing surfaces from damage, it also leads to additional thermal losses. Under the invention disclosed herein, thermal transfer of heat out of the engine block is limited while the internal bearing surfaces are protected from damage by a laminated inner cylinder sleeve that will behave as a thermal conductor thereby enabling much higher internal surface temperatures but minimizing internal forces and improving the materials of construction to maximize engine reliability and minimize inefficiencies due to heat losses. The invention also seeks to provide methods for controlling heat damage by using water injection within a thermal compression internal combustion heat engine to absorb excess heat while contributing to the thermal compression features of the system.

Although features referenced above will improve system efficiency over prior art systems by controlling thermal losses, rejected heat from engine cooling and waste heat from engine exhaust will still result in some thermal losses. Insufficient temperatures and pressures exist to convert the remaining heat into work. However, this remaining heat can be used to heat auxiliary systems that are practical for residential or business uses. Therefore, the concept of consuming a commercially available fuel for point-of-use electricity and heat production is introduced as both an efficient application of this high-efficient engine and a method for recovering waste heat from the engine for hot water generation, interior heating, or other heating applications that would be applicable for a stationary system that is dedicated to a specific residence or business facility.

Embodiments of the invention seek to provide year round, twenty-four hour per day, seven day per week point-of-use electrical power generation and energy management to afford a homeowner or a business cost advantages through energy efficiency, a sharp reduction in greenhouse gas emissions per Kwh consumed, and independence from outgases due to National Power Grid outages. Heat is typically wasted in prior art systems with work typically the only energy component that is of value for commercially available applications. Point-of-use, year-round power generation and energy management using a high-efficiency heat engine offers the benefits listed above while also enabling recovery of waste heat from the heat engine for storage and eventual use for further power generation or heating of potable water, interior heating, as well as other auxiliaries, thus utilizing a higher percentage of the potential energy available in a given quantity of purchased fuel for a practical use versus the 35 to 40% usage that is typical of prior art heat engine systems.

A programmable logic controller can determine the normal energy consumption for the user and determine when and how long the heat engine should operate to drive a generator to offset the electricity demands of the user. Waste heat is produced while the heat engine is operating. Heat from cooling and from exhaust can be captured and used to heat hot water to be retained, such as within a surge tank, where heat energy is also stored in batches. That heated water can then be utilized on demand as make-up water for the home hot water heater rather than using cold water directly from street service. With the make-up water already heated, energy is conserved during water make-up, and no or little energy is needed to be purchased from the National Power Grid (NPG). This approach can additionally be applied to baseboard heating elements or radiant floor heating and other applications with hot water from a surge tank containing waste heat being supplied to these applications to provide interior heating thereby further conserving energy.

One will appreciate that the foregoing discussion broadly outlines the more important goals and features of the invention to enable a better understanding of the detailed description that follows and to instill a better appreciation of the inventor's contribution to the art. Before any particular embodiment or aspect thereof is explained in detail, it must be made clear that the following details of construction and illustrations of inventive concepts are mere examples of the many possible manifestations of the invention.

### BRIEF DESCRIPTION OF THE DRAWINGS

FIG. 1a is a graph comparing a prior art thermal cycle to a thermal compression cycle;

FIG. 1b is a graph of a thermal compression cycle and waste heat recovery cycle;

FIG. 2a is a schematic flow diagram of components for a thermal compression cycle;

FIG. 2b is a schematic flow diagram of components for a thermal compression cycle and a waste heat cycle;

FIG. 3 is a view in front elevation of a hybrid thermal compression engine as taught herein;

FIG. 4a is a sectioned view in front elevation of an alternative thermal compression internal combustion heat engine with independent combustion and thermal compression chambers, cylinder heads containing valves, and opposing pistons as taught herein;

FIG. 4b is a sectioned view in side elevation of the engine of FIG. 4a;

FIG. 4c is a sectioned top plan view of the expander side of the engine of FIG. 4a;

FIG. 4d is a sectioned top plan view of the compressor side of the engine of FIG. 4a;

FIG. 4e is a view in front elevation of a gearing and timing chain arrangement for the drive shafts of the engine of FIG. 4a;

FIGS. 4f and 4g are cross-sectioned views in front and side elevation of the pistons and combustion surfaces of the engine of FIG. 4a;

FIG. 5a is a sectioned top plan view of a thermal compression waste heat recovery engine assembly pursuant to the invention;

FIG. 5b is a cross-sectioned sectioned view in side elevation of the thermal compression waste heat recovery engine assembly of FIG. 8a;

FIG. 6a is a sectioned top plan view of a pulse heat exchanger and rotary valve in an open position allowing air to enter the pulse heat exchanger;

FIG. 6b is a sectioned top plan view of the pulse heat exchanger and the rotary valve in an open position allowing air to exit the pulse heat exchanger;

FIG. 6c is a sectioned elevational view of the pulse heat exchanger and the rotary valve;

FIG. 6d is a view in front elevation of the rotary valve of FIG. 6a;

FIG. 6e is a view in front elevation of the rotary valve in FIG. 6b;

FIG. 7a is a sectioned top plan view of a pulse heat exchanger;

FIG. 7b is a sectioned view in front elevation of the pulse heat exchanger of FIG. 7a;

FIG. 8a is a sectioned view in front elevation of a pulse core vane;

FIG. 8b is a sectioned view in side elevation of the pulse core vane of FIG. 8a;

FIG. 9 is a view in side elevation of a plurality of individual pulse core vanes at multiple stages in a single cycle; and

FIG. 10 is a schematic of a system exploiting aspects of the present invention for point-of-use energy management.

### DETAILED DESCRIPTION OF PREFERRED EMBODIMENTS

It will be appreciated that the Thermal Compression and Waste Heat Recovery Heat Engine and Methods disclosed herein are subject to widely varied embodiments. However, to ensure that one skilled in the art will be able to understand and, in appropriate cases, practice the present invention, certain preferred embodiments of the broader invention revealed herein are described below and shown in the accompanying drawing figures. Before any particular embodiment of the invention is explained in detail, it must be made clear that the following details of construction, descriptions of geometry, and illustrations of inventive concepts are mere examples of the many possible manifestations of the invention.

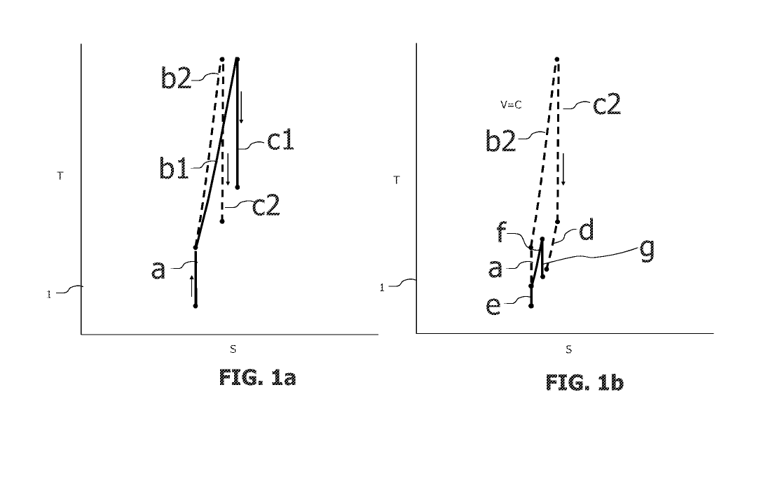

The thermal dynamic cycle with the thermal compression can be better understood by reference to FIG. 1a. The temperatures and pressures depicted are examples with it being provided that an unlimited combination of operating parameters can be applied. In FIG. 1a, temperature T is depicted along the vertical axis as a function of entropy S along the horizontal axis.

In a typical prior art internal combustion engine, intake air is isentropically compressed at stage ‘a’ from 14.7 pounds per square inch absolute to approximately 110 psia. At an intake temperature of 60F after compression, the temperature rises to approximately 495° F. Heat is added at a constant pressure at stage ‘b1’. The temperature rises to approximately 1784.5° F. as the pressure drops slightly due to internal losses and due to the piston's moving past top dead center and into the expansion stroke while combustion is ongoing. As such, the pressure peaks in the Auto cycle at about 108 psia. These conditions are met by air expansion during heat addition, raising the temperature to 1784.5° F. After heat transfer, isentropic expansion at stage ‘c1’ occurs where hot air expands to apply work in the expansion stage. Air temperature then drops to approximately 947° F. while the pressure reaches approximately 16.0 psia where it is exhausted. The difference in work between compression and expansion is the net work, which results in a net brake horse power output, which has unlimited applications including driving a generator or propelling a vehicle.

Again referring to FIG. 1a, one sees a dotted line where compressed air at the same pressure 110 psia and temperature 495° F. as discussed above is heated through combustion or simple heat transfer at a constant volume. Air confined to a constant volume while heating, results in a rise in pressure as depicted at stage ‘b2’. This results in the same target temperature of 1784.5° F. as described for the prior art version. However, it has been calculated that a resultant of 258.1 psia is reached compared to 108 psia at the same temperature as in the prior art approach. This process is referred to as thermal compression or an isochoric process. As a result, the expansion step at stage ‘c2’ is much longer and produces a much lower exhaust temperature calculated to be 668.8F compared to 947.0F as more energy is converted to work during expansion at stage ‘c2’ rather than remaining as heat as at stage ‘c1’. This results in a comparably higher net work output and better fuel efficiency.

In the example of FIG. 1a, the calculated energy conversion, potential energy to kinetic energy, is 33.3% for the prior art and 53.22% using the thermal compression method under a load. These percentages take into account many of the friction and thermal losses, which are estimated to be approximately the same for both scenarios. System efficiency approaching 49.2% was also calculated for the prior art and 64.5% for the thermal compression method described herein under no load.

These values are used for exemplary purposes only to compare the theoretical differences between the two methods keeping all other variables equal. The invention is not limited to these embodiments or these operating parameters. This thermal compression method can be applied in an unlimited combination of operating pressures and temperatures.

Pursuant to the present invention, additional potential energy can be converted to kinetic energy by recovering a portion of the remaining waste energy from the thermal compression cycle in FIG. 1a and adding a secondary thermal compression waste heat recovery cycle as illustrated in FIG. 1b. The T−s graph illustrates the same thermal compression internal combustion of the first cycle and adds a second cycle. In the second cycle, ambient air is isentropically compressed at stage ‘e’ to a lower pressure than at stage ‘a’. For example, 30 psia at 193.9° F. was chosen. 193.9° F. is below the exhaust temperature of the first cycle after expansion at stage ‘c2’ about 668.8° F. at 16.0 psia. As a result, heat can be transferred from the first cycle shown in dotted lines in FIG. 1b to the second cycle, which is shown in solid lines.

As exhaust gasses pass through a heat exchanger, the heat of the exhaust gasses transfers from stage ‘d’ to stage ‘f’ into the compressed air of the second cycle. The air in the second cycle rises in temperature during stage ‘f’ to approximately 609.9° F. at a constant volume. Through thermal compression, the pressure rises to approximately 49.6 psia. Simultaneously, the exhaust gas temperature from the first cycle drops through during stage ‘d’ to 314.6° F. as heat is transferred to the second cycle as shown during stage T.

After isentropic expansion at stage ‘g’, the work out of the system has been calculated to exceed the work in. Therefore, the net work recovery is an additional approximately 7.56% over the already 53.22% conversion from the first cycle. Again, it should be clear here and throughout the present disclosure that the performance of embodiments of the invention and comparisons to systems and methods according to the prior art are calculated according to thermodymanic theory. Therefore, the foregoing percentages and the comparisons thereof will be understood to be estimates under load conditions.

The total work output of the first and second cycles in combination as a hybrid system illustrated in FIG. 1b is approximately 60.8% total energy conversion under load or 72.9% under no load. These percentages take into account most of the thermal losses, but actual performance will likely vary. The percentages are presented to illustrate the stark differences between the prior art and the basic strategy of this disclosure of constant volume heat addition.

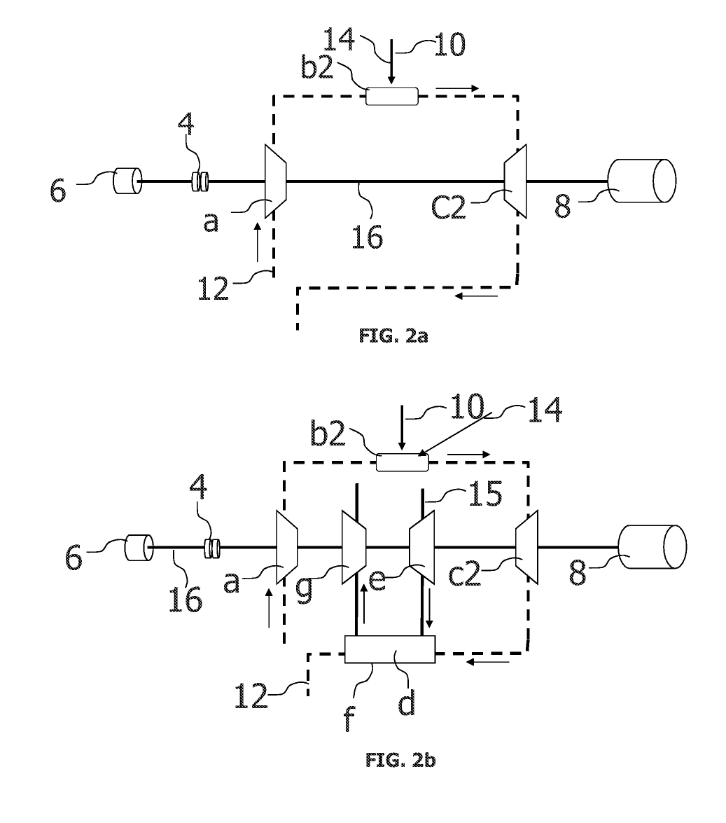

FIG. 2a illustrates key components of the first cycle. A compressor ‘a’, a combustion chamber ‘b2’, and an expander ‘c2’ are shown to be employed in the first cycle. These components and nomenclature align with the graphics on FIG. 1a. FIG. 2a illustrates additional components where a starter motor 6 initiates rotation. The starter motor 6 applies torque to the main drive shaft 16 until the engine turns over” and then disengages from the drive shaft 16 by the starter clutch 4. Ambient air enters the first cycle at 12 and passes from compressor ‘a’ to combustion and thermal compression chamber ‘b2’ as fuel is added at 10 to support combustion. Water may be injected at this point 14 to control thermal stresses on the materials and to aid in thermal compression. Hot compressed air exits the combustion and thermal compressor ‘b2’ and expands through expander ‘c2’ through the path illustrated by dotted line 12. The expander ‘c2’ continuously drives the main drive shaft 16 that can be used, among other things, to turn an appliance such as an electric generator 8.

FIG. 2b adds the second cycle to the first cycle as ambient air enters the system at solid line 15 and is compressed through the compressor ‘e’. Compressed air goes through thermal compression as heat is exchanged from the first cycle to the second cycle through heat exchanger ‘d’ and then is expanded by means of ‘g’ and is then discharged at line 15. The expander ‘g’ adds additional torque to drive shaft 16 as it converts waste heat to work. The alphanumeric elements of FIG. 2b coincide with the same elements in FIG. 1b.

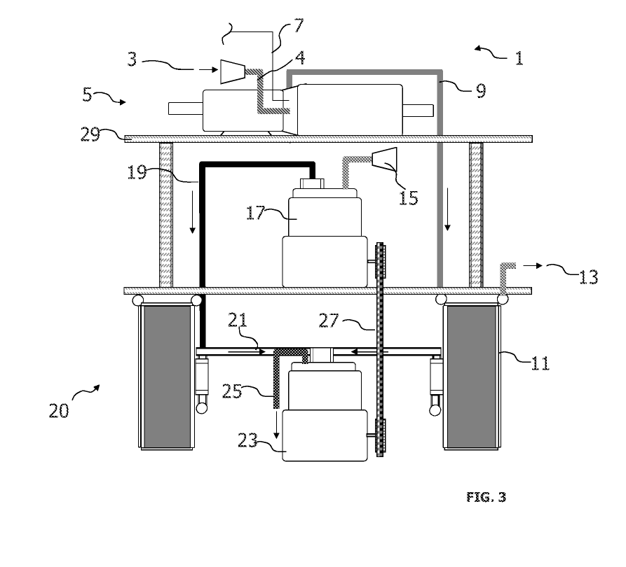

FIG. 3 illustrates all of the key components of a hybrid thermal compression engine 1 according to the invention. The hybrid thermal compression engine 1 can be seen to be formed by a thermal compression internal combustion heat engine 5 in cooperation with a thermal compression waste heat recovery engine 20. Ambient air enters an air filter 3 through an intake line 4 and enters into the thermal compression internal combustion heat engine 5 where air is compressed, combustion occurs, thermal compression occurs, and air is expanded all within engine 5. Exhaust gases exit engine 5 through line 9 and enter the pulse heat exchanger assembly 11, which is a component of the waste heat recovery engine 20 and where residual waste heat is given up into the pulse heat exchanger 11 and transferred to compressed air within the pulse heat exchanger 11. Cooled exhaust gases exit the pulse heat exchanger 11 into the atmosphere through line 13.

Intake air enters the second cycle through air filter 15 and is compressed by compressor 17. After compression, warm compressed air travels through line 19 into the pulse heat exchanger 11 where it is heated from hot exhaust gases passing through the thermal compression pulse heat exchanger 11 as discussed further below. Thermal compression occurs in the thermal compression pulse heat exchangers 11. Hot compressed air exits a multiplicity of thermal compression pulse heat exchangers 11 in series through lines 21 and supplies hot compressed air to drive expander 23. Hot air is isentropically expanded in expander 23 and is discharged through line 25. The compressor 17 and the expander 23 are timed by a timing belt 27 to assure a coordinated operation as described hereinbelow. All components are physically supported by frame 29.

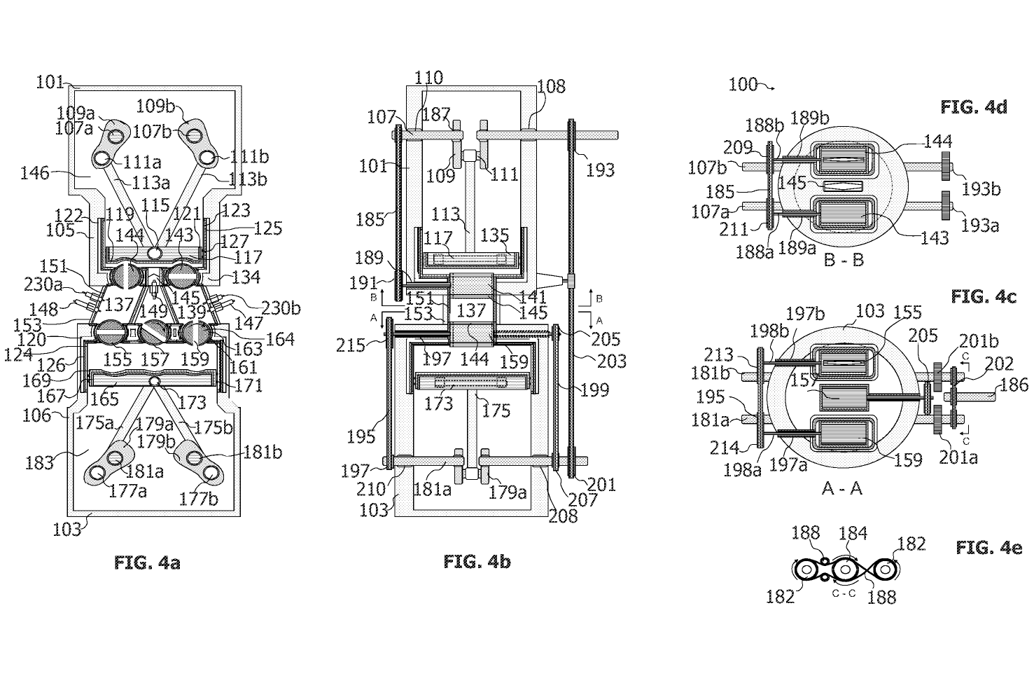

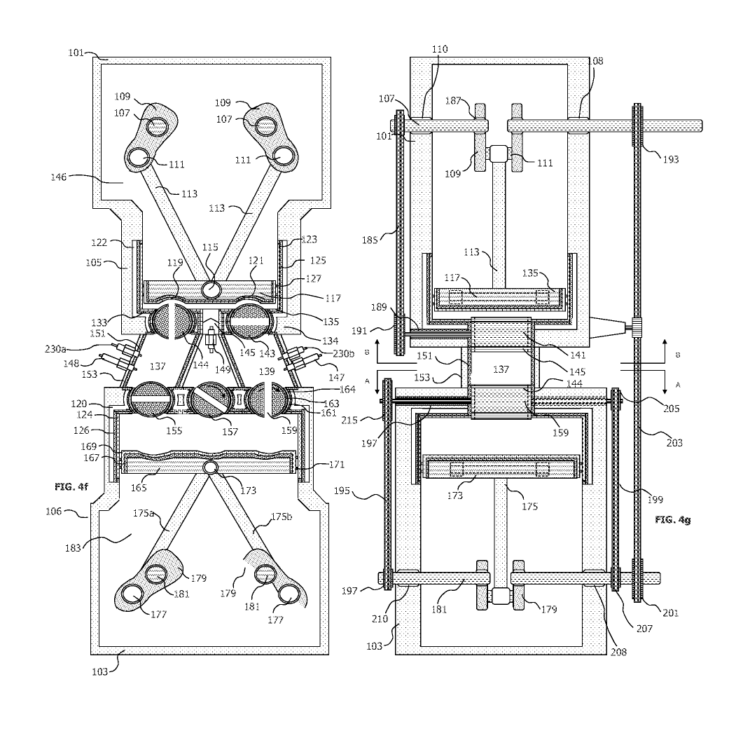

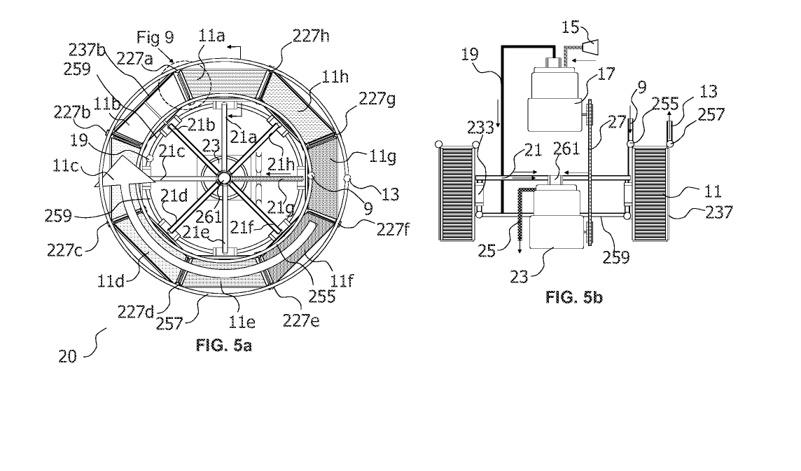

The first cycle driven by the thermal compression internal combustion heat engine 5 is described in detail in relation to FIGS. 4a though 4g, and the secondary air cycle driven by the waste heat recovery engine 20 is described in detail in relation to FIGS. 5 through 8.

The thermal compression internal combustion heat engine 5 as described further below has two combustion and thermal compression chambers external to the compressor and expander cylinders. Combustion and thermal compression alternate between the two chambers with every compression stroke. In addition, the system relies on two crank shafts to apply torque to the expander drive shaft and to impart torque to the compressor. Cylinder liners, insulation, and a water jacket between the liners and the engine blocks control thermal losses along with opposing pistons where intake air is mixed with fuel and isentropically compressed into a confined space. Combustion of an air/fuel mixture occurs in a static volume to take advantage of thermal compression after combustion is completed. Isentropic expansion then occurs to apply shaft torque which drives the compressor and provide excess power to drive an appliance such as a generator.

With combined reference to FIGS. 4a through 4g, ambient air is draw into the compressor 101 through a one-way intake valve 145 located in the head of the compressor 101. Fuel may be injected into the air stream during the intake stroke by a fuel injector 149. Piston 117 creates very little air gap with the compressor head 134 when at top dead center and, therefore, draws in mostly clean external air and unburned fuel into the compressor 101 in the down stroke. The compressor piston 117 is drawn down to bottom dead center by dual piston rods 113a and 113b that are connected to the piston 117 by pin 115 and connected to the crank shafts 107a and 107b and fly wheels 109a and 109b by pins 111a and 111b. The crank shafts 107a and 107b are turned by timing belt 203, which is driven by the expander 103. Two crank shafts 107a and 107b as well as associated piston rods 113a and 113b and drive shafts 109a and 109b are used to null out axial forces on the piston 117 and sealing/bearing surfaces 127 with the cylinder liner 123. Eliminating axial forces will reduce axial friction and extend engine life by reducing wear of these surfaces.

As the crank shafts 107a and 107b rotate past bottom dead center, the intake valve 145 closes and, in this example, the rotary valves 143 or 144 for one of a minimum of the two combustion and thermal compression chambers 137 and 139, a multiplicity of combustion chambers may apply, rotate open by means of timing belt 185 that rotate the valves at a speed and timing in coordination with the compressor crank shafts 107a and 107b rotational speed. As the compressor piston 117 drives toward top dead center, the air/fuel mixture increases pressure and temperature in the compressor cylinder 146 and also internal to the combustion and thermal compression chambers 137 or 139 with each combustion and thermal compression chamber 137 and 139 corresponding to a combustion chamber rotary valve 143 or 144. As the compression piston 117 approaches top dead center, the balance of the compressed air and fuel is forced into one of the open combustion and thermal compression chambers 137 or 139 due to the close tolerance gap between the head of the compression piston 117 and the compressor head 134 at top dead center.

Once compression is complete, the associated combustion and thermal compression chamber rotary valve 144 or 143 closes. The associated spark plug 147 or 148 may be energized, and combustion occurs within one of the combustion and thermal compression chambers 137 or 139. The corresponding combustion and thermal compression chamber rotary valve 144 or 143 and the corresponding expansion chamber rotary valve 155 or 159 remain closed during combustion and thermal compression and stay closed thereby allowing time for full combustion and thermal compression.

Simultaneously, the compression piston 117 once again begins its descent away from top dead center and starts toward bottom dead center. Intake air and fuel are once again drawn into the compression cylinder 146. Once the compression piston 117 reaches bottom dead center, the other combustion and thermal compression chamber rotary valve 144 or 143 not currently undergoing combustion opens, and the same cycle as previously described begins on the opposite side.

Compression, combustion, and thermal compression within the two combustion chambers 137 and 139, along with the opening and closing of the corresponding combustion chamber rotary valves 144 and 143, alternate with each compression stroke of the compression piston 117. The actual rotational speed of the valves is approximately 50% of the rotational speed of the drive shafts 107a and 107b. The rotational speed of the valves 144 and 143 is not limited to a timing gear and belt configuration; a cam or any other means made be employed to achieve the needed timing actuations of the valves 144 and 143 as needed to achieve thermal compression and continuous operation.

After combustion and thermal compression are completed, the corresponding expansion chamber rotary valve 155 or 159 opens, allowing a mixture of hot compressed air and post combustion gases to rush out into the expansion cylinder 183 while the applicable combustion and thermal compression chamber valve 144 or 143 remain closed. Simultaneously, the expander piston 165 is at top dead center and is forced down by the incoming expanding air applying force onto the head of the expander piston 165. The force applied to the head of the expander piston 165 imparts a force on piston rods 175a and 175b through pin 173, which in turn applies a force to the expander flywheels 179a and 179b through pins 177a and 177b. This downward force imparts a rotational force to crank shafts 181a and 181b sufficient to overcome the rotational force required to drive the compressor crank shafts 107a and 107b thereby producing excess power available to drive an appliance, such as a generator.

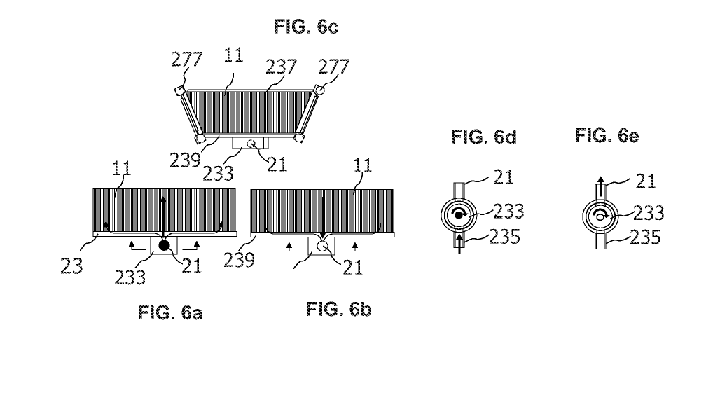

Drive shafts 181a and 181b are interconnected through a gear and chain arrangement with a center gear 184 driven by two counter-rotating drive gears 182a and 182b that are connected to drive shafts 181a and 181b. FIG. 6E depicts a drive chain 180 weaving between gears 182a, 184, and 182b to cause rotation in a single direction, clockwise or counter clockwise, for gear 184. The drive chain 180 on one side of center gear 184 is crossed while the same drive chain 184 on the opposite side of gear 184 is not crossed, thus creating rotation in a single direction for center gear 184 while drive gears 182a and 182b rotate in opposite directions.

As the expander piston 165 reaches bottom dead center, the applicable expander rotary valve 155 or 159 closes, and exhaust valve 157 rotates open. Fully expanded exhaust gases now present in the expander cylinder 183 are forced out of the expansion cylinder 183 by the expander piston 165 being forced back up to top dead center by the momentum of the fly wheels 179a and 179b and 109a and 109b. Exhaust gasses are forced out of the expander through the open rotary exhaust valve 157 until the expansion piston reaches top dead center and most of the exhaust gases are purged from the expansion chamber 183.

The rotational speed and timing of the rotary exhaust valve is also controlled by timing belt 195 and is approximately equivalent to the rotational speed of the drive shafts 107a and 107b as well as and 181a and 181b. As mentioned above, the rotational speed of the exhaust rotary valve 157 is not limited to a timing gear and belt configuration. A cam or any other means may be employed to achieve the needed timing actuations of the valve as needed to achieve thermal compression and, potentially, continuous operation.

Once at top dead center, the exhaust rotary valve 157 closes, and the opposite expander rotary valve 155 or 159 opens. This is the opposite valve 155 or 159 that was opened to drive the expander piston 165 on the prior stroke. The applicable expander rotary valve 155 or 159 opens and once again forces the expander piston 165 down to bottom dead center repeating the same cycle as previously described.

The two rotary expansion valves 155 and 159 alternate for every expansion stroke made by the expander piston 165, which ultimately converts a reciprocating motion to a rotary motion to drive the expander drive shafts 181a and 181b on a continual operating basis.

Therefore, the compression, combustion, thermal compression, and expansion of the air/fuel mixture that occurs in the two combustion chambers 137 and 139 alternate with each compression stroke of the compressor 101 and with every expansion stroke of the expander 103. The timing and speed of the corresponding combustion and thermal compression chambers rotary valves 144 and 143, the expansion chamber rotary valves 155 and 159, and the exhaust rotary valve 157 are controlled by timing belts 185 and 195 to ensure continual and alternating operation with each compression and expansion stroke. It will again be noted that the system and method are not limited to a timing gear and belt configuration. A cam or any other means made be employed to achieve the needed timing actuations of the valve as needed to achieve thermal compression and, potentially, continuous operation.

Cylinder liners 123 and 124 and piston liners 119 and 121 are made of high-temperature and high-tensile stress materials such as stainless steel or titanium. In addition, the rotary valve liners 163 and rotary valve seat liners 161 also utilize high-temperature and high-tensile stress materials such as stainless steel or titanium.

Behind all liners is insulation material 125, 126, and 164. In addition, the interior of all of the rotary valves discussed earlier is an insulated core. All insulation is located to minimize thermal losses through the engine blocks 105 and 106 during operation and is not limited to the locations described in illustrations. The adding or subtracting of locations along with the type and thickness of the insulation will be determined by experimentation and will vary to achieve the most thermally efficient operation as possible.

Behind insulation material 125, 126, and 164 is a water jacket intended to remove remaining heat passing through the insulation away from hot surfaces. Where the cylinder liners 123 and 124 and piston liners 119 and 169 will be made of high-temperature and high-tensile stress materials, such as stainless steel or titanium and contain self-lubricating materials, such as graphite impregnation, the surface temperatures can be allowed to go much higher than in prior art systems. While the same surface temperatures for prior art system are typically maintained below 180° F. to control damage to the engine block, the cylinder liners 123 and 124 and piston liners 119 and 169 disclosed herein can be allowed to heat up above 500° F. The thickness of the insulation material 125, 126, and 164 will be gauged to allow some heat flow into the jacket water passing through cooling jackets 120 and 122. The lamination between the cylinder liners 123 and 124 and insulation material 125, 126, and 164 creates a thermal path limiting heat flow. This scenario reduces the heat differential between the inner temperature of the cylinders 146 and 183 during operation and the water temperature within the cooling jackets 120 and 122, thus conserving energy within the system. The cylinder liner is made of high temperature alloys and of thin walled materials as compared to cast iron or aluminum as in prior art systems. Therefore, the elevated temperatures will be well within the fatigue temperatures of the materials of the present invention.

The timing of the compressor 101 and expander 103 are maintained through a timing belt 203 that transfers energy through timing gears 193 and 201 as the expander crank shafts 181a and 181b impart rotary force on the compressor crank shafts 107a and 107b. Both crank shafts 107a and 107b and 181a and 181b maintain synchronous timing through the teeth of timing belt 203 as they interconnect with the opposing teeth on the timing gears 193a and 193b and 201a and 201b fixed to the crank shafts 107a and 107b and 181a and 181b. Crank shaft bearings 108, 110, 208 and 210 assure low rotary resistance and mechanical support as the crank shafts 107a and 107b and 181a and 181b extend from the interior of the compressor 101 and expander 103 to the engine exterior so that external flanges and attachments can be made for power transfer to exterior applications.

FIG. 4c and FIG. 4d provide sectional top plan views of the compressor 101 and the expander 103. The rotary valves 143, 144, 155, and 159 on the heads of both components are highlighted as are the internal shafts 188a, 188b, 198a, and 198b that drive the rotary valves 143, 144, 155, and 159. The combustion chamber rotary valves 144 and 143 are illustrated as being driven by shafts 188a and 188b, which are fixed to timing gears 211 and 209. The shafts 188a, 188b, 198a, and 198b are insulated from the blocks by insulators 189a and 189b. Likewise, the expansion chamber rotary valves 159 and 155 are illustrated as being driven by shafts 198a and 198b which are fixed to timing gears 215 and 213. The shafts 198a and 198b are insulated from the blocks by insulators 197a and 197b.

Water injection 230a and 230b into the combustion and thermal compression chambers 137 and 139 after combustion as an option to aid in controlling thermal stresses of the internal liners and aid in the thermal compression step as atomized water flashes into superheated steam absorbs heat while the rapid increase in volume due to a phase change from liquid to gas supports thermal compression.

FIGS. 5a and 5b illustrate the second half of the thermal compression hybrid engine where the second cycle described earlier is realized by means of a waste heat recovery engine 20, which is made up of a series of thermal compression pulse heat exchangers 11a to 11h, a compressor 17, and an expander 23. FIGS. 5a and 5b depict the key components of the waste heat recovery engine 20 where ambient air is taken into a compressor 17 and compressed where the temperature rises with a corresponding pressure rise created by isentropic compression. Compressed air then exits the compressor 17 and carries through a post compression transfer line 19 and into the heat exchanger intake manifold 259. The heat exchanger intake manifold 259 encompasses the entire inner circumference along the series of thermal compression pulse heat exchangers 11a to 11h, which provide warm compressed air to each thermal compression pulse heat exchanger 11a to 11h equally.

Referring again to FIGS. 1b, and 2b and FIGS. 5a and 5b, a steady mass flow rate of warm compressed air ‘e’ enters a given thermal compression pulse heat exchanger 11a through 11h through dedicated rotary valves as discussed below and is heated by exhaust gases at ‘d’ exiting the thermal compression internal combustion heat engine 5 or some other heat source. With regard to the first cycle, for example, hot gases at ‘d’ travel down exhaust pipe 9 and enter the high-temperature exhaust manifold 255 where hot exhaust gases are distributed evenly around the inner circumference along the series of thermal compression pulse heat exchangers 11a to 11h.

Hot exhaust gasses ‘d’ enter one of the thermal compression pulse heat exchangers 11a through 11h through one of the complex valve assemblies 227a to 227h as shown in FIG. 5a. For example, hot exhaust gases ‘d’ enter thermal compression pulse heat exchanger 11f by means of complex valve assembly 227f where hot exhaust gases are supplied to complex valve assembly 227f by the high-temperature exhaust manifold 255. Hot exhaust gas enters thermal compression pulse heat exchanger 11f and passes a percentage of the available heat ‘d’ up to a given mass quantity of warm compressed air ‘f’ already present in the core of the thermal compression pulse heat exchanger 11£ Exhaust gases ‘d’ pass through the next complex valve assembly 227e into the next thermal compression pulse heat exchanger 11e where another percentage of heat ‘d’ is passed to a second fixed quantity of warm compressed air ‘f’ already resident in the core of thermal compression pulse heat exchanger 11e. Again, exhaust gases ‘d’ pass through the next complex valve assembly 227d into the next thermal compression pulse heat exchanger 11d where another percentage of heat is passed to a third fixed quantity of warm compressed air ‘f’ already resident in the core of thermal compression pulse heat exchanger 11d. Finally, exhaust gases ‘d’ pass through the next complex valve assembly 227c into the next thermal compression pulse heat exchanger 11c where another percentage of heat is passed to a fourth fixed quantity of warm compressed air ‘f’ already resident in the core of thermal compression pulse heat exchanger 11c. Exhaust gases ‘d’, now much cooler after passing through four thermal compression pulse heat exchangers 11f through 11c, finally exit thermal compression pulse heat exchanger 11c through complex valve assembly 227b and into the low-temperature exhaust manifold 257 where cooler exhaust gases are exhausted out of the system into the atmosphere or into another appliance through exhaust pipe 13.

For the second cycle, warm compressed air ‘f’ passes through transfer line 19 and into the heat exchanger intake manifold 259 through intake rotary valve 233f that opens and charges into thermal compression pulse heat exchangers 11f. There, it picks up heat from the final and fourth leg of the exhaust gases ‘d’ passing over the heat exchanger core.

Further details on how heat is transferred are discussed below. Heat from the first cycle exhaust gas ‘d’ is passed to the second cycle, such as through compressed air ‘f’ not flowing but temporarily static in the pulse heat exchanger 11f. As heat is added, thermal compression occurs as temperature rises and volume remains constant. As a result, internal pressure rises, which results in thermal compression for the warm compressed air ‘f’ resident in thermal compression pulse heat exchanger 11f. Heat transfer can occur for a predetermined period in thermal compression pulse heat exchanger 11f as intake rotary valve 233e opens and warm compressed air ‘f’ is charged into thermal compression pulse heat exchangers 11e where it picks up heat from the exhaust gases ‘d’ passing over the heat exchanger core. Warm compressed air ‘f’ resident in thermal compression pulse heat exchanger 11f is now exposed to heat from the exhaust gasses ‘d’ passing through thermal compression pulse heat exchanger 11f.

Warm compressed air ‘d’ resident in thermal compression pulse heat exchanger 11f receives a second round of heat at a higher temperature than during the first round. This process repeats two more times as the next round of exhaust gases ‘d’ heat the warm compressed air ‘f’ resident in the thermal compression pulse heat exchanger 11f, each time indexing the temperature higher as the entrance point the exhaust gases ‘d’ indexes from complex valve assembly 227a to 227f going clockwise on FIG. 5a over four fixed periods of time.

Likewise, the cooler exhaust gases ‘d’ exit the last complex valve assembly 227e to 227b indexing to the next thermal compression heat exchanger 11n every standard period. This causes exhaust gases ‘d’ to index down in temperature on every index for four indexes. Likewise, the temperature of a fixed quantity of warm compressed air ‘f’ resident in a single thermal compression heat exchanger 11n indexes up in temperature as four waves of exhaust gases ‘d’ at increasing temperatures pass over a given thermal compression pulse heat exchanger 11n.

Heat transfer occurs across four thermal compression pulse heat exchangers 11a through 11h at a time, each one at a higher temperature as warm compress air is exposed to heat longer and at increasing temperatures over four fixed indexes. A complex series of four heat exchangers index around to each thermal compression heat exchanger assembly 11a to 11h at a fixed rotational frequency and complete the entire circumference of all eight thermal compression heat exchangers 11a through 11h in a clockwise or counter clockwise direction over eight intervals for a continuous and repeating process.

Once warm compressed air is heated to its final temperature and thermal compression has occurred after four intervals of heat addition ‘f’, the applicable intake rotary valve, for example the intake rotary valve 233g, will open enabling hot compressed air ‘f’ to exit thermal compression heat exchanger 11g through expansion line 21g and into the expander rotary valve 261 and into the expander 23 where work is recovered through isentropic expansion of the hot compressed air ‘g’. After expansion, cooler and expanded air is discharged from the expander 23 through discharge line 25. At each of the eight intervals, the corresponding intake rotary valves 233g through 223h will open in series individually in a clockwise or counter-clockwise direction at each fixed index period. As each intake rotary valve 223g through 223h opens, the corresponding expansion line 21g through 21h carries hot compressed air to the expander rotary valve 261 and into the expander 23 to expand a fixed quantity of air to recover a finite quantity of work per index period.

As indicated above, FIG. 5a illustrates four thermal compression pulse heat exchangers 11f through 11c transferring heat energy from hot exhaust gases ‘d’ to warm compressed air ‘f’ through the heat exchanger cores. The other four thermal compression heat exchangers 11b through 11h are simultaneously performing other steps. For example, in FIG. 5a, warm compressed air ‘f’ resident within the thermal compression heat exchanger 11g has received all four stages of heat addition and is expanding through the rotary intake valve 233g into transfer line 21g through the rotary expansion valve 261 and into the expander 23. A the same time, thermal compression heat exchangers 11h and 11a have already expanded into the expander 23 in sequence and are idle retaining residual heat at a low pressure. Finally, thermal compression heat exchanger 11b is under compression where initially resident warm air containing waste heat is purged out through purge valve 24b, which opened upon the early stages of compression and then is quickly closed enabling air to be compressed into the thermal compression heat exchanger 11b by compressor 17.

Where indexing occurs continuously as the image of FIG. 5a indexes clockwise or counter-clockwise by one thermal compression heat exchanger 11g through 11h per index at a fixed period, the expander 23 operates continuously converting heat energy to work and discharging waste heat through the discharge line 25. The work recovered from the expander 23 drives the compressor 17 by means of timing belt 27. A sufficient amount of excess work is used to provide additional torque to a drive shaft to power an external device, such as a generator or appliance.

FIG. 6c illustrates the above components including two complex valve assemblies 277, discharge panel valve, intake diffuser 239, and rotary intake valve 233 assembled onto a single thermal compression pulse heat exchanger 11. Eight of these thermal compression pulse heat exchangers 11 are attached in series creating an octagon shape as illustrated in FIG. 5a. It should be noted that eight thermal compression heat exchangers 11 in series are discussed in this embodiment to explain the principle of a multitude of thermal compression heat exchangers 11 working together simultaneously to achieve compression, thermal compression, and expansion within the secondary air cycle. However, the invention is not limited to this quantity. One or more thermal compression pulse heat exchangers 11 may be used in series to achieve a secondary thermal compression air cycle. Eight assemblies were described to best detail the system dynamics but more or fewer thermal compression pulse heat exchangers 11 may be used to make up a thermal compression heat exchanger assembly.

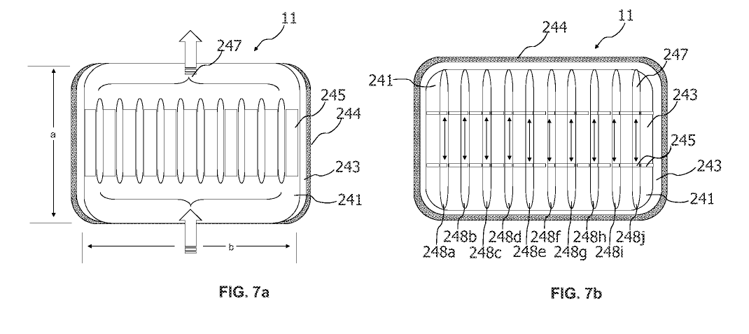

A typical thermal compression heat exchanger 11 is illustrated in FIGS. 7a and 7b. FIG. 7a depicts in a top plan view a thermal compression heat exchanger where hot exhaust gases ‘d’ enter the exhaust gas diffuser 241. The intake diffuser 239 of FIG. 6b allows exhaust gases ‘d’ to spread out evenly across a thermal compression pulse core 247 due to back pressure caused by air friction within the core 247. The back pressure enables incoming exhaust gases ‘d’ to provide even heating to all elements of the core 247.

Hot exhaust gases pass between the core elements 248a through 248j through to the back side of the thermal compression pulse core 247 giving up some of the resident heat within the exhaust gases ‘d’ through the individual core elements 248a through 248j and into the warm compressed air ‘f’ that is resident internal to each of the core elements 248a through 248j. FIG. 7b is a view in front elevation of the thermal compression heat exchanger 11 where thermal compression occurs as thermal heat within the exhaust gases ‘d’ give up heat to the warm compressed air ‘f’ as heat passes across the individual core elements 248a through 248j. The core elements 248a through 248j also provide mechanical support to contain warm air under pressure and increasingly higher pressure as the core elements and air within heat up as exhaust gases process through the thermal compression pulse core 247.

The individual core elements 248a through 248j are evenly spaced by spacers 245 placed between each core element 248a through 248j to control the amount of flexing the core elements will incur as the internal pressures continually fluctuate during normal operation. The spacers 245 are placed inside of each core element 248a through 248j and between the core elements 248a through 248j. The spacers are also placed between the first and last core elements 248a and 248j and the internal walls of the heat exchanger shell 243. The shell 243 of the heat exchanger 11 provides structural support to the entire thermal compression pulse core 247 as mechanical loads caused by internal pressures are transferred to the walls of the heat exchanger shell 243.

The heat exchanger shell 243 is made of rigid material, such as stainless steel or any other suitable material, and performs at least two functions. The heat exchanger shell 243 channels exhaust gases ‘d’ through the core 247 and provides structural support for the thermal compression pulse core 247 as the load is transferred through the spacers 245 to the walls of the heat exchanger shell 243. The exterior of the heat exchanger shell 243 is insulated 244 to prevent unwanted heat loss.

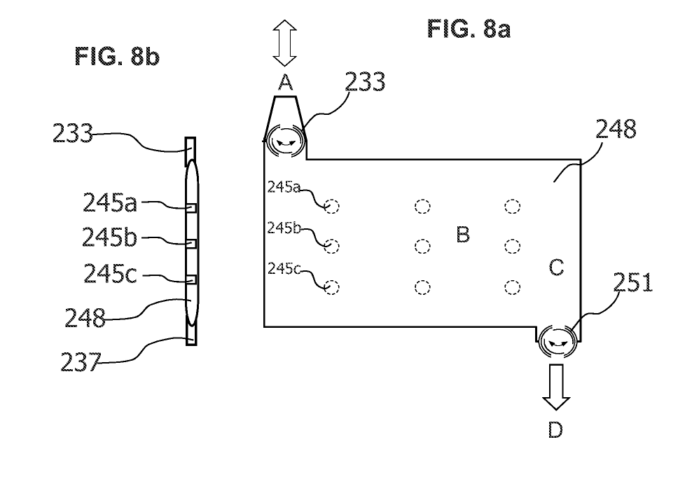

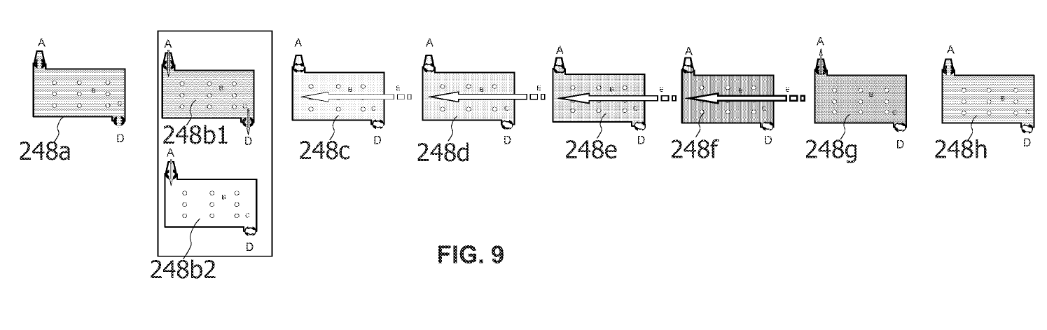

FIGS. 8a and 8b depict a single core element 248 with a rotary intake valve 233. FIG. 9 depicts a plurality of core elements 248a through 248h. In FIG. 9, one sees that, after being idle, warm compressed air ‘E’ is compressed into the core element 248b1, such as through the rotary intake valve 233 shown in FIGS. 8a and 8b. Fresh, warm compressed air ‘E’ purges warm resident air through a rotary discharge valve 251 as seen in FIG. 8 a or a panel discharge valve 237 as in FIG. 8b. After purging the rotary discharge valve 251 or the panel discharge valve 237, close and warm compressed air ‘E’ continues to be compressed into the core element 248b2 as illustrated in FIG. 9. Once the desired pressure and air mass is reached, the intake rotary valve 233 is closed.

The rotary intake valve 233 and the rotary discharge valve 251 remain closed as warm exhaust gases ‘D’ begin to heat the warm compressed air ‘F’ internal to the core element 248 as thermal compression begins. In three additional stages, heat for exhaust gases ‘D’ is transferred to the warm compressed air ‘F’ at increasing temperature levels giving up a percentage of the available heat within the exhaust gases at each of the four steps, thus completing the thermal compression step. Once the desired warm compressed air temperature is reached, the rotary intake valve 233 opens and allows the warm compressed air internal to the core element 248 to expand. Once the warm compressed air is fully expanded, the core element 248 containing residual heat is idle waiting the next purge and compression cycle. As the internal forces within the core element 248 change, spacers such as 245a, 245b and 245c provide physical support and structure to the walls of the core element 248.

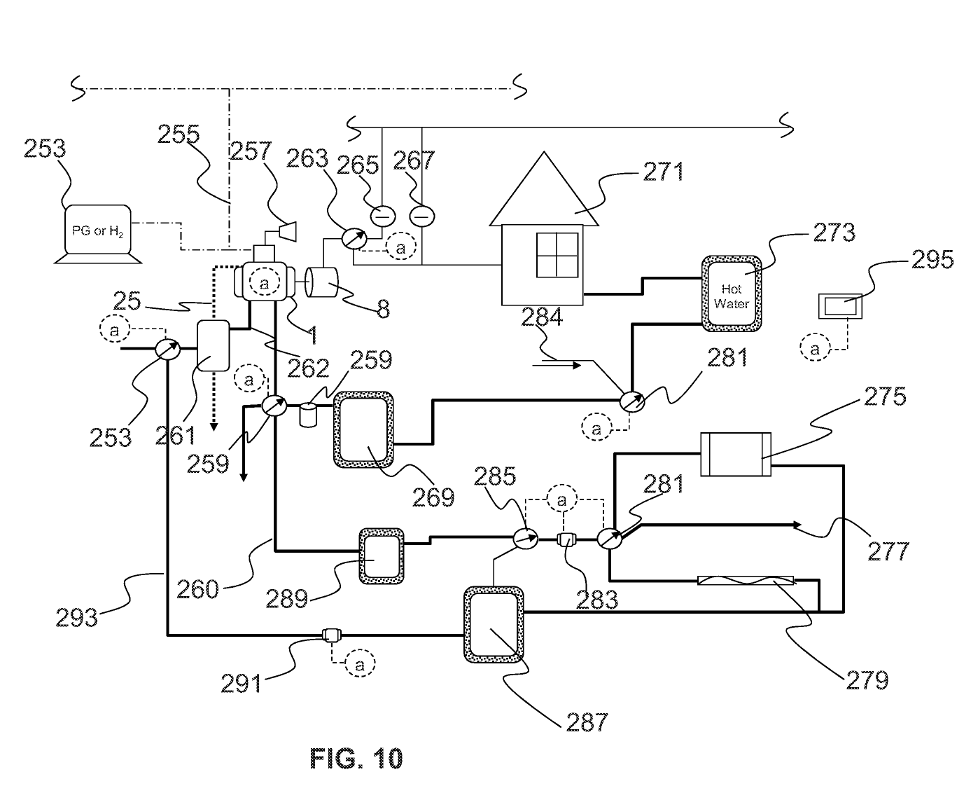

FIG. 10 depicts a point-of-use energy management system 300 exploiting the invention where gaseous fuel 255, such as natural gas or methane, supplied by a pipeline 253 or otherwise is stored in a pressurized tank and delivered to a hybrid internal combustion thermal compression and waste heat recovery thermal compression engine 1. The engine 1 drives an alternating current generator 8 at a constant rate and maintains that constant rate under varying loads.

To supply the annual electricity needs for a residence, a single pass hot potable water system makes a useful application of waste heat from engine 1. While the potable water street supply passes through a directional valve 253 and into an exhaust heat exchanger 261 where residual heat in the exhaust gases 25 from engine 1 is transferred to the potable water through a heat exchanger 261. Warm water 262 exits the heat exchanger 261 and passes through the cooling jacket of engine 1 picking up the remaining waste heat from the engine 1. Hot potable water then passes through a directional valve 259a and then through a filter 259b and accumulates in an insulated hot water accumulation tank 269. The water temperature may be well above a preferred temperature for internal potable hot water usage. However, an elevated temperature will conserve space required for the hot water accumulation tank 269. Hot water is then supplied to a control regulator 281 to permit a supply of hot water when demanded. A potable water supply line 284 is also connected to the control regulator 281 to blend cold street water with hot supplied water to adjust the water temperature for the residential hot water heater 273.

In addition, a second system that makes practical use of waste heat from engine 1 is internal residential heating, which includes a recycling system. Control valve 259a supplies hot water to an alternate path through line 260 supplying hot water to the secondary hot water accumulator 289. An unlimited number of other uses and axillaries are possible for this system. Only a few are mentioned to explain the basic concept of point-of-use energy generation and energy management.

Pursuant to the invention, all valves, regulators, pumps, and the actuation of the engine 1 are controlled by an energy management controller 295. That programmable logic controller 295 determines, among other things, how often the engine 1 turns on to supply energy and which demands are to be serviced at any given time.

With certain details of the present invention for Thermal Compression and Waste Heat Recovery Heat Engine and Methods disclosed, it will be appreciated by one skilled in the art that changes and additions could be made thereto without deviating from the spirit or scope of the invention. This is particularly true when one bears in mind that the presently preferred embodiments merely exemplify the broader invention revealed herein. Accordingly, it will be clear that those with certain major features of the invention in mind could craft embodiments that incorporate those major features while not incorporating all of the features included in the preferred embodiments.

Therefore, the following claims are intended to define the scope of protection to be afforded to the inventor. Those claims shall be deemed to include equivalent constructions insofar as they do not depart from the spirit and scope of the invention. It must be further noted that a plurality of the following claims may express certain elements as means for performing a specific function, at times without the recital of structure or material. As the law demands, these claims shall be construed to cover not only the corresponding structure and material expressly described in this specification but also all equivalents thereof that might be now known or hereafter discovered.

I claim as deserving the protection of Letters Patent:

1. A thermal compression and waste heat recovery system wherein waste heat resident in exhaust gases of a thermodynamic cycle is recovered and a portion of the waste heat is converted to work, the system comprising:
an internal combustion heat engine operative in a cycle to emit exhaust gases wherein the engine has a multiplicity of independent combustion chambers;
a multiplicity of thermal compression and expansion cylinders wherein the combustion chambers are separate from the thermal compression and expansion cylinders;
wherein the heat engine exhibits a pause in the cycle of the heat engine sufficient in time to induce a rise in temperature and a resultant pressure rise at a constant volume of gas in the thermal compression and expansion cylinders in an isochoric process due to combustion of a gas and fuel mixture in the combustion chambers; and
a heat transfer volume in thermal communication with the heat engine and means for drawing in a fluid into the heat transfer volume whereby heat is added to the fluid by means of the exhaust gases form the engine in an isochoric process.

2. The system of claim 1 further comprising an expander disposed to receive fluid from the heat transfer volume for converting thermal energy in the fluid to work.

3. The system of claim 1 wherein the heat transfer volume comprises a volume within a thermal compression pulse heat exchanger wherein heat from exhaust gases from the engine is transferred to a fluid confined in the heat transfer space at a constant volume resulting in a temperature and pressure rise to produce thermal compression.

4. The system of claim 3 wherein there is a network formed by a multiplicity of thermal compression pulse heat exchangers.

5. The system of claim 1 wherein the compression and expansion cylinders are lined with high-temperature resistant, thin-walled high tensile strength alloy liner and wherein insulation is disposed between the alloy liner and the compression and expansion cylinders to control heat losses.

6. The system of claim 1 further comprising water injectors to introduce a water mist into a compression space in the engine during an intake stroke to control internal temperatures and to assist thermal compression;

7. The system of claim 1 wherein the compression and expansion cylinders each comprise a piston, a cylinder, and a cylinder head and wherein the multiplicity of combustion and thermal compression chambers are thermally interconnected.

8. The system of claim 1 wherein the compression and expansion cylinders each further comprise a multiplicity of valves internal to the cylinder head that open and close in coordination with compression, combustion, thermal compression, and expansion steps of the thermodynamic cycle of the engine.

9. The system of claim 1 wherein there are a multiplicity of overlapping thermodynamic cycles equaling the number of thermal compression cylinders.

10. The system of claim 1 wherein each compression and expansion cylinder has two piston rods and two drive shafts to apply forces to a single piston to minimize axial forces on the piston during intake, compression, expansion, or exhaust.

11. The system of claim 1 further comprising a network of cooling jackets disposed in thermal communication with the compression and expansion cylinders to remove excess heat therefrom as working fluid is pumped though the jackets absorbing and removing excess heat.

12. The system of claim 1 wherein waste heat in the exhaust from the engine is converted to work by a system comprising a plurality of thermal compression pulse heat exchangers wherein the heat transfer volume comprises a volume within each thermal compression pulse heat exchanger wherein thermal energy from the exhaust gas is transferred into compressed air within the heat transfer volumes to achieve thermal compression with a pressure rise as a result of a temperature rise of compressed air contained within a constant volume.

13. The system of claim 12 further comprising an air compressor assembly in fluidic communication with the thermal compression pulse heat exchangers that raises pressure and temperature of ambient air by applying mechanical work to compress air and transfer compressed air into the heat transfer volume within the thermal compression pulse heat exchangers.

14. The system of claim 13 further comprising an air expander that recovers mechanical work from compressed air received from one or more of the thermal compression pulse heat exchangers.

15. The system of claim 12 wherein the thermal compression pulse heat exchangers are interconnected to form a loop.

16. The system of claim 12 wherein each thermal compression pulse heat exchanger is associated with a rotary valve that opens to allow compressed air to enter the thermal compression pulse heat exchanger, closes to cause heat to be transferred into the air to produce thermal compression, and then opens to enable hot compressed air to exit.

17. The system of claim 12 wherein the heat transfer volume is disposed to receive potable water whereby heat is transferred to the potable water from the exhaust gases from the engine.

18. A thermal compression and waste heat recovery method using the system of claim 1.
